(19) United States
(12) Patent Application Publication
(10) Pub. No.: US 2004/0058168 A1
(43) Pub. Date: Mar. 25, 2004

(54) Method for incorporating anionic molecules into a substrate for increasing dispersibility of anionic molecules

(76) Inventors: Charles A. Cody, Nashville, IN (US); Paul Carey, Montclair, NJ (US); Youssef Awad, North Brunswick, NJ (US); William Neuberg, Perrineville, NJ (US)

Correspondence Address: BAKER & BOTTS, 30 ROCKEFELLER PLAZA, NEW YORK, NY, 10112

(21) Appl. No.: 10/622,682

(22) Filed: Jul. 18, 2003

Related U.S. Application Data
(60) Provisional application No. 60/396,657, filed on Jul. 18, 2002.

(51) Int. Cl. B32B 17/06

(52) U.S. Cl. 428/428

(57) ABSTRACT

The present invention generally provides a method for increasing the dispersibility of an anionic molecule of interest by reacting the anionic molecule of interest onto the surface of a cationically modified substrate having a high surface area. The present invention further provides for the resulting compositions whereby an anionic molecule of interest has been incorporated onto the surface of a cationically modified high surface area substrate and where the resulting anion/cationically modified substrate composition (such as an anion/organoclay composition) experiences greater dispersibility in a target application system than the anionic molecule of interest alone experiences in that same application system. The method of the present invention further serves to substantially reduce the water solubility of the anionic molecule of interest by incorporating it into a cationically modified high surface area substrate such as an organoclay. Also, the method of the present invention serves to improve the efficacy of the anionic molecule of interest.

### FIELD OF THE INVENTION

The present invention generally relates to a method for increasing the dispersibility of an anionic molecule of interest by (1) reacting the negatively charged portion of the anionic molecule with an organic cationic compound to form a complex and then ion-exchanging the complex onto the surface of a substrate having a high surface area and/or (2) reacting an organic cationic compound onto the surface of a high surface area substrate and then reacting the negatively charged portion of the anionic molecule with the organic cationic compound. More particularly, the present invention provides a method for evenly and completely dispersing the anionic molecule of interest over an extremely large surface area, so that once the anionic molecules are dispersed, they remain non-soluble in aqueous and organic environments. The present invention further relates to compositions resulting from the reaction of an organic cationic compound located on the surface of a high surface area substrate with an anionic molecule of interest, wherein the resulting compositions, which comprise the anionic molecule of interest, have significantly enhanced dispersibility in an application system when compared to the dispersibility of the anionic molecule of interest alone in the same application system.

### BACKGROUND OF THE INVENTION

Organoclays, including chemically modified smectite-type clays such as bentonite or hectorite, are analogous to very thin sheets of paper in that the clay particles are long in width and length and have a very high surface area per unit weight. Smectite-type clays and methods for their preparation are disclosed in U.S. Pat. No. 4,664,820 to Magauran et al., which is hereby incorporated by reference in its entirety. Organoclays are further characterized in that they contain mobile organic cations at their surface, which can be readily ion-exchanged with other cations when such organoclays are placed in water. The mobile cations located on the surface of an organoclay may include, but are not limited to, Na⁺, Li⁺, K⁺, NH₄⁺, H⁺, Ca²⁺, Mg²⁺, and Fe²⁺. Since these cations are mobile, they may be replaced by other cations, such as quaternary ammonium compounds, referred to herein as “quats”, which comprise a positively charged nitrogen-containing organic ionic portion associated with a negative ion such as Cl⁻ or Br⁻.

Typically, quats ionize in water. For example, a quat such as (CH₃)₂—N⁺—[(CH₂)₁₇—CH₃]₂—Cl⁻ is able to ionize in water and exchange onto the surface of a high surface area substrate such as a clay so that the resulting organoclay has a surface that is coated with cationic organics. The surface coverage of the quat on the clay surface is complete or near complete so that an organic system will then disperse the organoclay because of the organic surface modification of the organoclay. Thus, the inclusion of a cationic organic compound such as a quat onto the surface of the clay provides a surface with a high compatibility for dispersion in organic systems. In addition, the cationic quat serves to neutralize the negative charges on the surface of the clay.

It is known that anionic compositions such as anionic dyes comprise a negative portion, and an offsetting positive portion, or cation. For an anionic dye, the negative portion is the colored part or the part that absorbs light from the visible and/or ultraviolet portion of the spectrum. When such anionic dyes are placed in water, they typically dissolve or dissociate into anions and cations, wherein the anionic portion colors the system. However, when such dyes are used in systems other than water (namely, organic systems), the anionic dyes do not disperse well due to their ionic character. Therefore, anionic dyes typically remain non-soluble and non-dispersible in organic systems. In addition, if anionic dyes do disperse (to some extent) either in water or in an organic system, the dyes typically are easily washed out, i.e., they bleed if and when the entire system is later exposed to water.

Thus, a need exists for a method whereby an anionic molecule of interest can experience greater dispersibility in a system such as an organic system. The invention disclosed herein addresses this and other needs.

The use of an organophilic clay gellant has been disclosed in U.S. Pat. No. 4,412,018 to Finlayson et al. In Finlayson, the objective of the invention described therein is to use the clay as a thickening agent, and any anionic molecule portions used therein are simply present to enhance the properties of the organoclay. In addition, the disclosure of Finlayson et al. does not disclose the use of an organoclay to enhance the properties of an anionic molecule of interest.

Similarly, U.S. Pat. No. 5,804,613 to Beall et al. and U.S. Pat. No. 6,242,500 to Lan et al. disclose an intercalate, wherein material may be added to a clay to enhance the dispersibility of the clay. Beall et al. and Lan et al. do not contemplate the enhancement of the chemical properties of an anionic molecule of interest through increasing the dispersibility of such anionic molecules.

In addition, U.S. Pat. No. 4,434,075 and U.S. Pat. No. 4,517,112 to Mardis et al. disclose modified organophilic clays but do not contemplate a method by which the dispersibility and the chemical and/or physical properties of an anionic molecule of interest are greatly increased and/or enhanced through the reaction of such an anionic molecule of interest with an organic cationic compound located on the surface of the clay.

None of the above-cited documents recognizes or suggests the selection of an anionic molecule of interest based on its inherent chemical or physical properties or useful features. Rather, any anionic molecules disclosed in these patents are present solely to enhance the dispersibility and gelling ability of the organoclay.

In contrast, the present invention is based upon (1) selecting an anionic molecule of interest for the desirable chemical and/or physical effects it contributes to a desired application system, (2) enhancing the efficacy of that anionic molecule of interest by incorporating it into an organoclay or some other cationically modified high surface area substrate, and (3) stabilizing that anionic molecule of interest through the use of an organoclay or other cationically modified high surface area substrate, where the substrate acts as a surface for attaching and increasing the available surface area of the anionic molecule of interest. In turn, the resulting composition (such as an organoclay which now comprises the anionic molecule of interest) experiences enhanced dispersibility in the desired application system, such as an organic system, and experiences an enhanced ability to impart its desirable chemical and/or physical properties to that application system.

In short, a need exists for a method of reacting an anionic molecule of interest (such as an anionic dye) having a desired chemical property (such as coloring a system) with a high surface area substrate, such as a clay, that has undergone cation exchange to include an organic cationic compound on its surface, so that the dispersibility of the anionic molecule of interest is greatly increased, thereby enhancing the ability of the anionic molecule of interest to impart its desired chemical property to a given system. In addition, a need exists for a method of reacting an anionic molecule of interest onto the surface of an organoclay or other high surface area substrate so that the anion is able to disperse in systems where it typically would not disperse. The present invention addresses these and other needs.

### SUMMARY OF THE INVENTION

The present invention relates to a method for increasing the dispersibility of and enhancing the chemical and/or physical properties of an anionic molecule of interest by reacting the negatively charged or anionic portion of that molecule with an organic cationic compound, such as a quaternary nitrogen compound (a “quat”), that is incorporated on the surface of a high surface area substrate such as a clay. The invention provides methods and compositions that permit an anionic molecule of interest to be evenly and completely dispersed over an extremely large surface area, and to be non-soluble in an application system of interest. Thus, the present method provides the desired result of substantially diminishing the water solubility of the anionic molecule of interest while simultaneously keeping the anion fixed and viable over an extremely large surface.

The present invention also presents a method whereby an anionic dye is essentially converted into an anionic pigment, since pigments are generally known to be non-soluble in aqueous environments. Thus, the problems typically encountered by anionic dyes (such as bleeding and the like) are eliminated or at least substantially diminished by the method of the present invention whereby such anionic dyes are bound to a cationically modified substrate such as an organoclay.

Certain preferred embodiments described herein employ an organoclay as the substrate having high surface area that is able to increase the dispersibility of the anionic molecule of interest. As the dispersibility of an anionic molecule of interest is increased, the ability of the anionic molecule of interest to impart its desired chemical or physical properties or effects to an application system of interest is greatly increased. Thus, for example, if an anionic dye is incorporated onto the surface of an organoclay according to the present invention and the anion/organoclay composition is placed into a system where the anionic dye alone typically has difficulty dispersing, the resulting increased dispersibility of the anionic dye will increase the ability of the anionic dye to color the desired system, and color strength and intensity will increase proportionately when compared to the color strength and intensity of the anionic dye alone in that system. Therefore, the present invention further provides an improved method of coloring a system whereby an anionic dye is reacted with an organoclay, and the resulting anion/organoclay composition's ability to color a given system (and to remain non-soluble in that system) is greater than that of the anionic dye alone.

In the process of the present invention, the anionic portion of the anionic molecule of interest (for example, the anionic portion of an anionic dye) is ionically bound to an organic cationic compound such as a quat. The organic cationic compound (such as a quat) either has been previously reacted or ion-exchanged onto the surface of a high surface area substrate (such as a clay particle), or the quat and the anion of interest are first bound together and the pair is subsequently ion-exchanged onto the surface of the substrate.

The method of the present invention is useful for anionic molecules that are able to be ionically bound to an organic cationic compound such as a quat when both are in water. Typically, it is suggested that the anion/quat solubility product or Kₛₚ have a value of 10⁻² grams²/100 mL of H₂O, or less, wherein the Kₛₚ may be defined as [anion][quat], and where [ ] denotes concentration in grams per 100 mL of water.

Anionic dyes are examples of anionic molecules of interest that benefit from the method of the present invention. However, the anionic molecule of interest does not have to be colored or contain a chromophore, but instead can be any negatively charged portion of a molecule, wherein that negative portion is what carries or supplies the chemical effect to be imparted to a given system. When anionic dyes are employed as the anionic molecule of interest in the present invention, the negatively charged portion of the dye is what supplies or carries the coloring effect to the system. Similarly, certain pigments, pharmaceutical compounds, catalysts, redox reagents, initiators, and the like are useful in the present invention if the anionic portion of such compounds is the portion that supplies the desired chemical effect to the system of choice.

The substrate onto which the anionic molecule of interest is incorporated may be, but is not limited to, a clay, such as a smectite-type clay, a silicate, such as a zeolite, and other organic or inorganic substances which have exchangeable cations at their surface and which possess high surface area. Thus, substrates useful in the present invention include organic or inorganic materials that possess a high surface area per unit weight value (such as about 0.1 m²/g or higher) and that are capable of attaching the anionic molecule of interest via organic cation(s) located at the surface of the substrate. Materials such as attapulgite, vermiculate, and organic resins capable of exchanging cations (and subsequently binding the anionic molecule of interest to the exchanged cations) may be appropriate in the present invention.

In certain preferred embodiments of the present invention, a smectite-type clay such as bentonite clay is employed as the high surface area substrate. Using clay as the substrate in this method provides both high surface area and a reactive surface (due to ion exchange capability), which leads to the successful organic modification of the surface of the clay through ion-exchange of a cation (such as a quat) and the subsequent binding of the anionic molecule of interest to the organically modified clay surface. The organoclay serves to eliminate the anion's solubility in various systems, greatly increases the dispersibility of the anion, and greatly increases the available surface area of the anion. In certain embodiments, the determination of the increase of the available surface area of the anion is made by comparing the available surface area of a dry composition containing the anion with the available surface area of an anion/organoclay composition according to the present invention. Generally, the method of the present invention leads to an increase in the efficacy of the properties of the anionic molecule of interest.

When an organoclay is employed in the present method, the anion/organoclay composition comprising, for example, a bound anionic dye or pigment, may be used to color powders, cosmetics, toners, rubbing compounds, buffing compounds, inks, resins, coatings, and paints. In addition, such organoclay-bound anionic dyes or pigments may be used to color plastics, elastomers, extruded solids, and the like.

When an anionic pharmaceutical compound is bound to an organoclay, the resulting anion/organoclay composition may be useful as a medicinal agent. One example includes zinc ricinoleicite and ricinoleic acid (useful in treating athlete's foot), whereby the ricinoleiate anion may be bound to the surface of an organoclay according to the present invention and thus have greater exposed surface area and a greater treatment ability. Thus, for anionic medicinal agents, the present invention is advantageous in that instead of having particles where only the surface of the particles interacts with the system to be treated and the bulk of the particle is on the interior and is inert, the anionic medicinal agent/organoclay composition's particles have a much larger active fraction at the exact same weight loading because of the great increase in surface area.

The method of the present invention may be carried out in several different ways. For example, an organic cationic compound (such as a quat) may be reacted or ion-exchanged first onto the surface of the substrate, such as a clay, and subsequently the anionic molecule of interest is reacted with the quat that is already bound to the clay in the form of an organoclay. In addition, the anionic molecule of interest may be reacted first with an organic cationic compound, such as a quat, and subsequently the anion/quat pair is ion-exchanged onto the surface of the substrate, such as a clay. The anion/quat pair may be displaced from the substrate into an organic application system to a small degree when smectite-type clays or similar substrates are used. However, upon such minor displacement, the equilibrium of the system still strongly favors the anion/organoclay composition. Thus, in the case of an anionic dye being employed in such a system, the bleeding of the anionic dye into the system would be, at worst, significantly reduced rather than completely eliminated.

The present invention is further described below with respect to certain specific embodiments.

### BRIEF DESCRIPTION OF THE DRAWINGS

Further objects and advantages of the present invention will be more fully appreciated from a reading of the detailed description when considered with the accompanying drawings, wherein:

FIGS. 1(A) and (B) show diagrammatically two methods by which an anionic molecule of interest may be reacted onto the surface of a high surface area substrate, wherein the substrate shown is a clay.

### DETAILED DESCRIPTION OF THE INVENTION

The present invention relates to a method for increasing the dispersibility of an anionic portion of a molecule by incorporating the anion onto the surface of a high surface area substrate such as a clay surface. Specifically, the present method involves ionically binding the anionic portion of the molecule of interest to a cationic compound (for example a quaternary nitrogen compound or “quat”) which has been ion-exchanged onto the surface of the substrate such as the clay. The present invention provides a method that permits any anionic molecule of interest to be completely and evenly dispersed over a large cationically modified surface area in a non-soluble form, provided that the anion/cation complex (such as the anion/quat complex) is one that is relatively insoluble. The present invention further provides compositions, such as anion/organoclay compositions, which result from the reaction of a cationic organic compound, such as a quaternary nitrogen compound, found on the surface of a high surface area substrate, such as a clay, with an anionic molecule of interest.

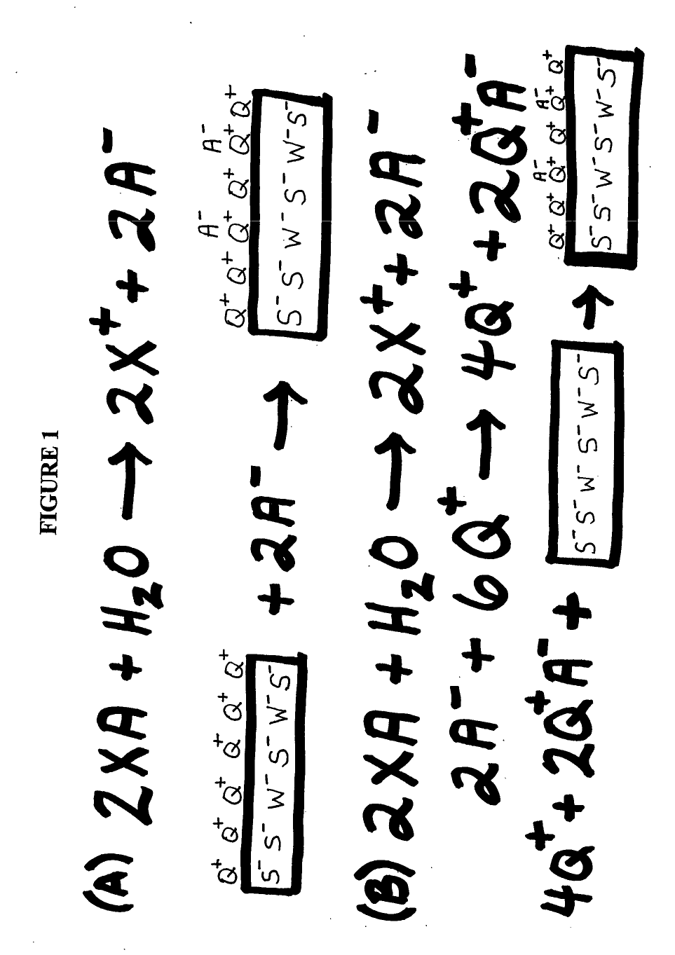

In certain embodiments of the present invention, the anionic molecule of interest is first reacted with an organic cationic compound, such as a quat, in water. The anion/quat complex is then reacted onto the surface of the high surface area substrate by reacting with the “weak” bonding sites located on the substrate. Such embodiments are depicted by FIG. 1(B).

Specifically, in FIGS. 1(A) and (B), the anionic molecule of interest is shown as “XA” when the anionic portion (A⁻) is combined with a neutralizing cation (X⁺). The molecule of interest dissociates in water into “X⁺” and “A⁻”, wherein “A⁻” represents the anionic portion of the molecule of interest that provides a certain property to an application system (such as coloration of that system). As shown in FIG. 1(B), the “A⁻” then reacts with quat (represented by “Q⁺”) to form the anion/quat complex, shown as “Q⁺A⁻.” The anion/quat pair is then able to react onto the surface of the clay (shown as a sheet or plate-like rectangle) at the weak bonding sites located on the clay (which are represented by “W⁻”).

Not wishing to be bound by theory, it is believed that the surface of a clay carries two types of charges, a strong bonding charge and a weak bonding charge, and thus the clay comprises strong and weak bonding sites, which are represented as “S⁻” and “W⁻” respectively in FIGS. 1(A) and (B). When an organic cationic compound, such as a quat, is reacted with a clay, a portion of the cationic quat is completely charge-neutralized by the clay by reacting at the strong bonding sites, while the remaining portion of the cationic quat is only partially charge-satisfied and is bound to the weak bonding sites on the clay. Thus, the quat that is bound at the weak bonding sites and that carries the remaining partial positive charge remains available to bind to the anionic molecule of interest, which is thereby incorporated over the surface of the organoclay.

In other embodiments of the present invention, the organic cationic compound, such as a quat is mixed first with clay in water, and the resulting organoclay is subsequently mixed with the anionic molecule of interest. Such embodiments are represented by the reaction diagram in FIG. 1(A), wherein quat is first reacted onto the surface of the clay and is bound at both the strong and weak bonding sites on the clay. As discussed above, the quat that is bonded to the weak bonding sites is not completely charge-satisfied or charge-neutral, and thus retains enough positive charge to bind the anionic molecule of interest to form the resulting anion/organoclay composition. In still other embodiments of the present invention, the anionic molecule of interest is first mixed with clay, and the anion/clay pair is then reacted with the organic cationic compound such as quat.

Many possible end uses exist for compositions formed according to the present invention. Specifically, organoclays employing a dye or a pigment as the anionic molecule of interest may be used to color powders and may be used in cosmetics, toners, rubbing and buffing compounds. In addition, the anion/organoclay compositions formed herein may be used in drug applications, such as being mixed in with aspirin, Mg(OH)₂, CaCO₃, or the like. Also, the resulting anion/organoclay compositions formed herein may be dispersed, with at least low to medium intensity mixing, into paints, coatings, lubricants, resins (including polyester), alkyds, oils, greases, and various other organic fluids.

Furthermore, the dry powder form of the anion/organoclay compositions formed herein may be blended with powders, polymers, resins, and the like, and thereby used in dry form. Also, such blended powders incorporating the dry powder form of the anion/organoclay compositions formed herein may be melted or melt extruded for use in materials such as thermoplastics. For example, a blended powder incorporating a dry powder form of an organoclay/anion composition formed according to the present invention could be used to color nanocomposite-containing materials, such as the nanocomposite thermoplastic olefin materials described in Rose, J., “Nanocomposite TPO Part Is Ready to Hit the Road for GM,” Modern Plastics, (October 2001), p. 37, which is hereby incorporated by reference herein in its entirety. Specifically, in such embodiments, the colored nanocomposite thermoplastic olefin materials could be used in automotive parts as well as other applications.

Any anion capable of ionic binding to the quat in water can be used in the method of the invention. The negative charge on the anion can result from any of the common species known to produce such charges, including but not limited to, —COO⁻(acid), —SO₃⁻, —SO₄⁻², —PO₃⁻³, —PO₄⁻³, —NO₃⁻—, and the like. Representative examples of molecules comprising such an anionic portion include but are not limited to certain catalysts, pharmaceutical compounds, reaction intermediates, dyes, and pigments. Specific examples of anionic molecules of interest that may be useful in the present invention include, but are not limited to: pyocyanine, which produces a blue solution in water; calcium 2-ethylbutanoate, which may be useful as a stabilizer or as a sedative; aluminum lactate, which may be useful in foam fire extinguishers or in dental impression materials; and aluminum nicotinate, which may be medically useful as a peripheral vasodilator, as a cholesteropenic, or as a lipopenic agent.

In certain preferred embodiments of the present invention, an anionic dye is used as the anionic molecule of interest to react with an organic cationic compound (such as a quat) located on the surface of a high surface area substrate. An anionic dye may be defined as any anionic substance, natural or synthetic, which is soluble and is used to color various materials.

In addition to dyes, anionic pigments may also be ionically bound to a high surface area substrate (such as an organoclay), via reaction with the organic cations on the substrate's surface. Specifically, pigments are finely divided water-insoluble colored substances, possibly from about 0.05 μm to about 5 μm in size, which are able to color a system to which they are added. Pigments do not experience the same problems as dyes, such as the problem of bleeding when in certain aqueous environments. But pigments suffer from the fact that the bulk of the colored portion of the pigment powder is unable to provide color to the system because the majority of the pigment particle is buried deep within the interior.

Specifically, for anionic pigments, the colored anionic portion is reacted with a counter cation to form an insoluble, nonionic material that is ground or powdered to particles of very small particle size as mentioned above. Thus, in embodiments of the present invention where an anionic pigment is the anionic molecule of interest, the cationically modified substrate such as an organoclay serves as the counter ion, and a nonionic, high surface area material is formed that can then be used to color a system. An example of such a useful pigment is Lithol Rubine B, wherein instead of Ca²⁺ acting as the counter cation, the cationically modified organoclay acts as the counter ion when Lithol Rubine B is incorporated into an organoclay according to the present invention. Thus, the present method, wherein the dispersibility of an anionic pigment is greatly increased, better allows such a pigment to color a given application system by increasing the surface area of the pigment available to that system.

As described above, high surface area substrates that may be utilized in the practice of the present invention include, but are not limited to, any material comprising mobile cations that are capable of exchanging with organic cationic compounds to be dispersed on the surface of the substrate. Organic cationic compounds useful in the present invention may be selected from a wide range of compounds having a positive charge localized on a single atom or a group of atoms within the compound. In certain preferred embodiments, the organic cationic compound selected is a quaternary ammonium salt.

The present invention also contemplates the idea that when a high surface area substrate such as a clay is treated with an excess of the cationic organic compound (for example, an amount of cationic quat that exceeds 100% of the clay's total Cation Exchange Capacity or “CEC”), the excess quat is absorbed nonionically onto the clay surface and remains available to bond ionically to the anionic molecule of interest. Furthermore, the present invention contemplates methods by which the anionic molecule of interest is first ionically bonded to a cationic compound such as a quat in solution, and where the anion/quat pair is subsequently absorbed or exchanged onto the surface of the substrate, such as the clay.

In certain embodiments of the present invention, smectite-type clays, particularly bentonite and hectorite, may be selected as the high surface area substrate. Bentonite clay is highly dispersible in water and results in numerous particles with an extremely high surface area. On average, one can approximate a bentonite clay particle in water as having the dimensions of 0.1 μm in length, 0.1 μm in width, and 10 Å in thickness. This clay also is well known to contain exchangeable cations on its surface. When dispersed in water, the surface exchangeable cations, such as Na⁺, Ca²⁺ and Mg²⁺, can be exchanged with organic cations, such as quaternary ammonium salts (“quats”), to form the organoclay. The formation and use of organoclays are described in U.S. Pat. No. 5,759,938 issued Jun. 2, 1998 to Cody et al.; U.S. Pat. No. 5,735,943 issued Apr. 7, 1998 to Cody et al.; U.S. Pat. No. 5,725,805 issued Mar. 10, 1998 to Kemnetz et al.; U.S. Pat. No. 5,696,292 issued Dec. 9, 1997 to Cody et al.; U.S. Pat. No. 5,667,694 issued Sep. 16, 1997 to Cody et al.; U.S. Pat. No. 5,634,969 issued Jun. 3, 1997 to Cody et al.; and U.S. Pat. No. 4,664,820 issued May 12, 1987 to Magauran et al.; all of which are incorporated herein by reference in their entirety.

Also described in the above-referenced patents are additives which may be employed to assist in further increasing the dispersibility of the anionic molecule of interest through incorporating such anions into, for example, organoclay materials as disclosed herein. Examples of suitable additives include, but are not limited to, polar activators, such as acetone; preactivators, such as 1,6 hexane diol; intercalates, such as organic anions; and mixtures thereof. Such additives are also described in U.S. Pat. No. 5,075,033 to Cody et al.; U.S. Pat. No. 4,894,182 to Cody et al.; and U.S. Pat. No. 4,742,098 to Finlayson et al.; which are all incorporated herein by reference in their entirety.

Organoclays may be prepared by reacting a certain type of clay with an organic cation. Any clay, which can be reacted with one or more organic cations to provide binding of an anionic molecule of interest, can be used in the method and compositions of the present invention. Preferable clays include smectite-type clays, which are well known in the art and are available from a variety of sources. The clays can also be converted to the sodium form if they are not already in this form. This can conveniently be done by preparing an aqueous clay slurry and passing the slurry through a bed of cation exchange resin in the sodium form. Alternatively, the clay can be mixed with water and a soluble sodium compound, such as sodium carbonate, sodium hydroxide, or the like, and the mixture may be sheared, for example, using a pugmill or extruder. Conversion of the clay to the sodium form can be undertaken at any point before the ion-exchange with the organic cationic compound, such as a quat.

Smectite-type clays prepared synthetically by either a pneumatolytic or, preferably, a hydrothermal synthesis process can also be used to prepare the organoclay compositions used in the method of the present invention. Representative smectite-type clays which are useful in the present invention include, but are not limited to, the following:

Montmorillonite having the general formula:

[(Al₄₋ₓMgₓ)Si₈O₂₀(OH)_{4-ƒ}F_{ƒ}]ₓR⁺

where 0.55≦x≦1.10, f≦4 and where R is selected from the group consisting of Na, Li, NH₄, and mixtures thereof;

Bentonite having the general formula:

[(Al₄₋ₓMgₓ)(Si_{8-y}Al_{y})O₂₀(OH)_{4-ƒ}F_{ƒ}]_{(x+y)}R⁺

where 0<x<1.10, 0<y<1.10, 0.55≦(x+y)≦1.10, f≦4 and where R is selected from the group consisting of Na, Li, NH₄ and mixtures thereof;

Beidellite having the general formula:

[(Al_{4+y})(Si_{8-x-y}Al_{x+y})O₂₀(OH)_{4-ƒ}F_{ƒ}]ₓR⁺

where 0.55≦x≦1.10, 0≦y≦0.44, f≦4 and where R is selected from the group consisting of Na, Li, NH₄ and mixtures thereof;

Hectorite having the general formula:

[(Mg₆₋ₓLiₓ)Si₈O₂₀(OH)_{4-ƒ}F_{ƒ}]ₓR⁺

where 0.57≦x≦1.15 f≦4 and where R is selected from the group consisting of Na, Li, NH₄, and mixtures thereof;

Saponite having the general formula:

[(Mg_{6-y}Al_{y})(Si_{8-x-y}Al_{x+y})O₂₀(OH)_{4-ƒ}F_{ƒ}]ₓR⁺

where 0.58≦x≦1.18, 0≦y≦0.66, f≦4 and where R is selected from the group consisting of Na, Li, NH₄, and mixtures thereof; and

Stevensite having the general formula

[(Mg₆₋ₓ)Si₈O₂₀(OH)_{4-ƒ}F_{ƒ}]₂ₓR⁺

where 0.28≦x≦0.57, f=4 and where R is selected from the group consisting of Na, Li, NH₄, and mixtures thereof.

The preferred clays used in the present invention are bentonite and hectorite, with bentonite being the most preferred. The clays may be synthesized hydrothermally by forming an aqueous reaction mixture in the form of a slurry containing mixed hydrous oxides or hydroxides of the desired metals with or without, as the case may be, sodium (or alternate exchangeable cations or mixtures thereof) fluoride in the proportions defined by the above formulas and the preselected values of x, y, and f for the particular synthetic smectite-type clay desired. The slurry is then placed in an autoclave and heated under autogenous pressure to a temperature within the range of approximately 100° to 325° C., preferably 275° to 300° C., for a period of time sufficient to form the desired product. Formulation times of from about 3 hours to about 48 hours are typical at 300° C., depending on the particular smectite-type clay being synthesized; the optimum time can readily be determined by pilot trials.

Representative hydrothermal processes for preparing synthetic smectite-type clays are described in U.S. Pat. Nos. 3,252,757, 3,586,478, 3,666,407, 3,671,190, 3,844,978, 3,844,979, 3,852,405 and 3,855,147, all of which are herein incorporated by reference.

A variety of organic cationic compounds may be used to form the organoclay, which thereby enhances the dispersibility of the anionic molecule of interest. Specifically, the organic cationic compounds useful in the present method must have a positive charge localized on a single atom or on a small group of atoms within the compound. The organic cation is preferably an ammonium cation which contains at least one linear or branched, saturated or unsaturated alkyl group having 12 to 22 carbon atoms. The remaining groups of the cation are chosen from (a) linear or branched alkyl groups having 1 to 22 carbon atoms; (b) aralkyl groups which are benzyl and substituted benzyl moieties including fused ring moieties having linear or branched 1 to 22 carbon atoms in the alkyl portion of the structure; (c) aryl groups such as phenyl and substituted phenyl including fused ring aromatic substituents; (d) beta, gamma-unsaturated groups having six or less carbon atoms or hydroxyalkyl groups having two to six carbon atoms; and (e) hydrogen.

The long chain alkyl radicals may be derived from naturally occurring oils including various vegetable oils, such as corn oil, coconut oil, soybean oil, cottonseed oil, castor oil and the like, as well as various animal oils or fats such as tallow oil. The alkyl radicals may likewise be petrochemically derived, for example, from alpha olefins.

Representative examples of useful branched, saturated radicals include 12-methylstearyl and 12-ethylstearyl. Representative examples of useful branched, unsaturated radicals include 12-methyloleyl and 12-ethyloleyl. Representative examples of unbranched saturated radicals include lauryl; stearyl; tridecyl; myristyl (tetradecyl); pentadecyl; hexadecyl; hydrogenated tallow, docosanyl. Representative examples of unbranched, unsaturated and unsubstituted radicals include oleyl, linoleyl, linolenyl, soya and tallow.

Additional examples of aralkyl, that is benzyl and substituted benzyl moieties, would include those materials derived from, e.g., benzyl halides, benzhydryl halides, trityl halides, α-halo-α-phenylalkanes wherein the alkyl chain has from 1 to 22 carbon atoms, such as 1-halo-1-phenylethane, 1-halo-1-phenyl propane, and 1-halo-1-phenyloctadecane; substituted benzyl moieties, such as would be derived from ortho-, meta- and para-chlorobenzyl halides, para-methoxybenzyl halides, ortho-, meta- and para-nitrilobenzyl halides, and ortho-, meta- and para-alkylbenzyl halides wherein the alkyl chain contains from 1 to 22 carbon atoms; and fused ring benzyl-type moieties, such as would be derived from 2-halomethylnaphthalene, 9-halomethylanthracene and 9-halomethylphenanthrene, wherein the halo group would be defined as chloro, bromo, iodo, or any other such group which serves as a leaving group in the nucleophilic attack of the benzyl type moiety such that the nucleophile replaces the leaving group on the benzyl type moiety.

Examples of aryl groups would include phenyl such as in N-alkyl and N,N-dialkyl anilines, wherein the alkyl groups contain between 1 and 22 carbon atoms; ortho-, meta- and para-nitrophenyl, ortho-, meta- and para-alkyl phenyl, wherein the alkyl group contains between 1 and 22 carbon atoms, 2-, 3-, and 4-halophenyl wherein the halo group is defined as chloro, bromo, or iodo, and 2-, 3-, and 4-carboxyphenyl and esters thereof, where the alcohol of the ester is derived from an alkyl alcohol, wherein the alkyl group contains between 1 and 22 carbon atoms, aryl such as a phenol, or aralkyl such as benzyl alcohols; fused ring aryl moieties such as naphthalene, anthracene, and phenanthrene.

The β, γ-unsaturated alkyl group may be selected from a wide range of materials. These compounds may be cyclic or acyclic, unsubstituted or substituted with aliphatic radicals containing up to 3 carbon atoms such that the total number of aliphatic carbons in the β, γ-unsaturated radical is 6 or less. The β, γ-unsaturated alkyl radical may be substituted with an aromatic ring that likewise is conjugated with the unsaturation of the β, γ-moiety or the β, γ-radical is substituted with both aliphatic radicals and aromatic rings.

Representative examples of cyclic β, γ-unsaturated alkyl groups include 2-cyclohexenyl and 2-cyclopentenyl. Representative examples of acyclic β, γ-unsaturated alkyl groups containing 6 or less carbon atoms include propargyl; allyl(2-propenyl); crotyl(2-butenyl); 2-pentenyl; 2-hexenyl; 3-methyl-2-butenyl; 3-methyl-2-pentenyl; 2,3-dimethyl-2-butenyl; 1,1-dimethyl-2-propenyl; 1,2-dimethyl propenyl; 2,4-pentadienyl; and 2,4-hexadienyl. Representative examples of acyclic-aromatic substituted compounds include cinnamyl(3-phenyl-2-propenyl); 2-phenyl-2-propenyl; and 3-(4-methoxyphenyl)-2-propenyl. Representative examples of aromatic and aliphatic substituted materials include 3-phenyl-2-cyclohexenyl; 3-phenyl-2-cyclopentenyl; 1,1-dimethyl-3-phenyl-2-propenyl; 1,1,2-trimethyl-3-phenyl-2-propenyl; 2,3-dimethyl-3-phenyl-2-propenyl; 3,3-dimethyl-2-phenyl-2-propenyl; and 3-phenyl-2-butenyl.

The hydroxyalkyl group is selected from a hydroxyl substituted aliphatic radical wherein the hydroxyl is not substituted at the carbon adjacent to the positively charged atom, and the group has from 2 to 6 aliphatic carbons. The alkyl group may be substituted with an aromatic ring independently from the 2 to 6 aliphatic carbons. Representative examples include 2-hydroxyethyl (ethanol); 3-hydroxypropyl; 4-hydroxypentyl; 6-hydroxyhexyl; 2-hydroxypropyl (isopropanol); 2-hydroxybutyl; 2-hydroxypentyl; 2-hydroxyhexyl; 2-hydroxycyclohexyl; 3-hydroxycyclohexyl; 4-hydroxycyclohexyl; 2-hydroxycyclopentyl; 3-hydroxycyclopentyl; 2-methyl-2-hydroxypropyl; 1,1,2-trimethyl-2-hydroxypropyl; 2-phenyl-2-hydroxyethyl; 3-methyl-2-hydroxybutyl; and 5-hydroxy-2-pentenyl.

Thus, the organic cation used when modifying a clay into an organoclay for use in the present invention may be considered as having at least one of the following formulae:

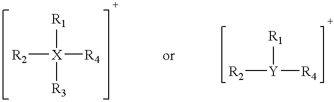

wherein X is nitrogen or phosphorus, Y is sulfur, R₁ is the long chain alkyl group and R₂, R₃ and R₄ are representative of the other possible groups described above.

A preferred organic cation contains at least one linear or branched, saturated or unsaturated alkyl group having 12 to 22 carbon atoms and at least one linear or branched, saturated or unsaturated alkyl group having 1 to 12 carbon atoms. The preferred organic cation may also contain at least one aralkyl group having a linear or branched, saturated or unsaturated alkyl group having 1 to 12 carbons in the alkyl portion. Mixtures of these cations may also be used.

Especially preferred organic cations are an ammonium cations where R₁ and R₂ are hydrogenated tallow and R₃ and R₄ are methyl or where R₁ is hydrogenated tallow, R₂ is benzyl and R₃ and R₄ are methyl or a mixture thereof such as 90% (equivalents) of the former and 10% (equivalents) of the latter.

Specifically, a quat such as dimethyl dihydrogenated tallow quat (“2M2HT”) may be used in the present invention, when it is desired to increase the dispersibility of the anionic molecule of interest in non-polar organic systems, whereas a dimethyl tallow benzyl quat may be used when it is desired to increase the dispersibility of the anionic molecule of interest in aromatic systems. Thus, the specific quat to be employed is selected according to the identity of the final application system into which the user desires to increase the dispersibility of the anionic molecule of interest.

As earlier mentioned, the organic cation such as a quat is associated with a neutralizing anionic portion, which portion will not adversely affect the reaction product or the recovery of the same. Such anions may be chloride, bromide, iodide, hydroxyl, nitrite and acetate in amounts sufficient to neutralize the organic cation.

The preparation of the organic cationic salt such as a quaternary ammonium salt can be achieved by techniques that are well-known in the art. For example, when preparing a quaternary ammonium salt, one skilled in the art would prepare a dialkyl secondary amine, for example, by the hydrogenation of nitrites, see U.S. Pat. No. 2,355,356, and then form the methyl dialkyl tertiary amine by reductive alkylation using formaldehyde as a source of the methyl radical. According to procedures set forth in U.S. Pat. Nos. 3,136,819 and 2,775,617, quaternary amine halide may then be formed by adding benzyl chloride or benzyl bromide to the tertiary amine. The contents of these three patents are hereby incorporated by reference.

As is well known in the art, the reaction with benzyl chloride or benzyl bromide can be completed by adding a minor amount of methylene chloride to the reaction mixture so that a blend of products which are predominantly benzyl substituted is obtained. This blend may then be used without further separation of components to prepare the organophilic clay.

Illustrative of the numerous patents which describe organic cationic salts, their manner of preparation and their use in the preparation of organophilic clays are commonly assigned U.S. Pat. Nos. 2,966,506, 4,081,496, 4,105,578, 4,116,866, 4,208,218, 4,391,637, 4,410,364, 4,412,018, 4,434,075, 4,434,076, 4,450,095 and 4,517,112, the contents of which are hereby incorporated by reference in their entirety.

The amount of organic cation (such as a quat) to be reacted with the smectite-type clay depends upon the specific type of clay being employed. As seen in the Examples below, the optimal clay:quat ratio may be determined using the well-known methylene blue spot test. The end point of this spot test is used to calculate the Cation Exchange Capacity (CEC) for a given type of smectite-type clay. This CEC value is thereby used in calculating the optimal clay:quat ratio for the specific type of clay.

The CEC value for a given clay may be useful in determining the amount of quat to add to the clay to convert it into an organoclay. For example, the user may desire to add an excess of quat to a sample of bentonite clay. As discussed earlier, this addition of an excess of quat results in some of the quat being bound to the strong bonding sites on the clay and thereby being completely charge-neutralized, while the remainder of the quat (or the portion of the quat not bound to the strong bonding sites on the clay) is bound to the weak bonding sites on the clay. The portion of the quat bound to the weak bonding sites retains some of its positive charge and is therefore able to bind with the anionic molecule of interest. Thus, the user may decide, for example, to use an amount of quat that satisfies from over 100% to about 130% of the clay's CEC, in order to guarantee that a true “excess” amount of quat is used.

The compositions of the invention include a wide range of anionic molecules of interest wherein the anionic molecule of interest carries or supplies the chemical effect to be imparted to a given system. Examples of anionic molecules of interest include, but are not limited to, pigments, pharmaceutical compounds, catalysts, initiators, Redox agents, dyes and the like. The sought after chemical effect, such as coloring for dyes and/or pigments or medicinal activity can be quantitatively measured by a number of techniques which are specific to the chemical activity sought. In general, for each specific molecule of interest, a series of quantitative measurements are carried out on the pure chemical of interest and on the inventive compositions at equal concentrations of the chemical molecule of interest, then the measurements compared to determine the relative improvement. For example, to quantitate the decrease in water solubility of the inventive composition versus, for example pure dye itself, one can employ ultra violet visible spectroscopy to measure the relative intensity or absorption of the dye itself at a given concentration in water versus that of the same dye concentration in the inventive composition in water after filtering the composition in water to remove solids.

To measure the decreased water leachability, the inventive composition and the chemical of interest itself can be dispersed into an application system of interest. Then soxhlet extraction can be carried out on both application samples and the extracted water can be analyzed for the chemical ingredient of interest by a variety of techniques such as ultraviolet visible analysis of the water extract, determining the residue weight upon drying the water extracts etc.

The method and compositions of the present invention may be better understood through the working Examples detailed below. These Examples are intended to illustrate the invention and should not be construed as limiting the invention in any way.

### EXAMPLES

### Example 1

### General Determination of Useful Anionic Compounds

At the outset of the method of the present invention, it must first be determined if a particular chemical ion or molecule will be able to undergo the method of enhancing its dispersibility and thereby its anionic properties as disclosed herein. Thus, a determination must be made (for example, if the ionic character of a certain compound is unknown) whether or not the ion or molecule comprises a useful anionic portion that will react with a cationic compound (such as a quat) which (1) is already reacted onto the surface of a substrate such as a clay or (2) is to be reacted onto the surface of such a substrate after reacting with the anion of interest. Thus, the molecule or ion can be tested in order to determine whether it has an anionic character (and thus can undergo the present method) or a cationic character or a neutral character. In testing certain molecules or ions, the procedure described below was employed.

The six samples tested for whether or not they may undergo the process of the present invention included: Jarocol Straw Yellow dye, D&C Red No. 22 dye; FD&C Blue No. 1 dye; Methylene Blue laboratory reagent dye; FD&C Yellow No. 5 dye; and Lithol Rubine B. Specifically, D&C Red No. 22 is a well-known xanthene color (CAS Number 548-36-5) having the empirical formula C₂₀H₈Br₄O₅.2Na. FD&C Blue No. 1 is a well-known triphenylmethane color (CAS Number 3844-45-9) having the empirical formula C₃₇H₃₆N₂O₉S₃.2Na. FD&C Yellow No. 5 dye (CAS Number 1934-21-0) is a well-known pyrazole color having the empirical formula C₁₆H₁₂N₄O₉S₂.3Na. Also, for the Lithol Rubine B, the complex that is normally used to form Lithol Rubine B was used before complexation with Ca²⁺.

Using Jarocol Straw Yellow dye as a representative example, four 1 mg samples of the dye were weighed and placed in 4 test tubes. Then, 10 mg of an organoclay powder was added to the first test tube; 10 mg of “clean” clay (or clay that does not comprise a quaternary ammonium compound (quat) cationically modifying its surface) was added to the second test tube; 10 mg of quat was added to the third test tube; and the fourth test tube contained only the Jarocol Straw Yellow dye sample to be used as the control sample.

Subsequently, 10 mL of water was added to each of the four test tubes, and all of the samples were mixed well for 30 seconds. The samples from each of the test tubes were then centrifuged for 15 minutes in a laboratory scale centrifuge.

Next, the resulting centrifuged samples were examined and analyzed (by being compared to the control sample) to determine whether the Jarocol Straw Yellow dye reacted with the organoclay, the clean clay, or the quat, so that it could then be decided if Jarocol Straw Yellow dye has the requisite anionic character to undergo a reaction with the organoclay and thereby have increased dispersibility in various application systems. The analysis herein was performed visually, since the six samples tested were dyes. However, non-dye samples may be analyzed by infrared spectroscopy, differential scanning calorimetry (DSC), gas chromatography, UV spectroscopy, thermogravimetric analysis, or the like to determine whether a given non-dye sample has the requisite anionic character to be useful in the present invention. For example, for a non-dye sample, the clay may be separated from the water, both parts may be taken to dryness, and the IR spectrum of each may be recorded.

Just as Jarocol Straw Yellow dye was tested using the four test tubes, the other five dye samples were similarly tested. The results are shown below in Table 1:

TABLE 1

| | Test Tube 1 | Test Tube 2 | | Test Tube 4 |
|---|---|---|---|---|
| | (10 mg | (10 mg | Test Tube 3 | (Control, |
| Sample (1 mg) | Organoclay) | “Clean” clay) | (10 mg Quat) | sample only) |
| Jarocol Straw | Organoclay was | Clay layer was | Quat had a | Water was dark |
| Yellow dye | light yellow; | yellow; water | slight tint of | yellow |
| | water layer also | layer was clear | yellow; water | |
| | light yellow | | layer was dark | |
| | | | yellow | |
| D&C Red No. | Organoclay | Clay layer had | Quat layer was | Water was dark |
| 22 dye | layer was red; | its natural | light pink; | red |
| | water layer was | color; water | water layer was | |
| | clear | layer was red | red | |
| FD&C Blue | Organoclay | Clay layer had | Quat layer was | Water was dark |
| No. 1 dye | layer was blue; | its natural | light blue; | blue |
| | water layer was | color; water | water layer was | |
| | light blue | layer was blue | blue | |
| Methylene | Organoclay | Clay layer was | Quat layer was | Water was dark |
| Blue, | layer was blue; | dark blue; | light blue; | blue |
| laboratory | water layer also | water layer was | water layer was | |
| reagent dye | blue | clear | dark blue | |
| FD&C Yellow | Organoclay | Clay layer had | Quat layer was | Water was dark |
| No. 5 dye | layer was | its natural | light yellow; | yellow |
| | yellow; water | color; water | water layer was | |
| | layer was clear | layer was | yellow | |
| | | yellow | | |
| Lithol Rubine B | Organoclay | Clay layer had | Quat layer was | Water was red |
| | layer was red; | its natural | red; water layer | |
| | water layer was | color; water | was clear | |
| | light red | layer was red | | |

The visual results recorded in Table 1 above reveal that of the six dye samples tested, the Lithol Rubine B dye formed a highly insoluble reaction product with the quat. This is evident by looking at the results for Test Tube 3 for Lithol Rubine B where the quat layer was dark red and the water layer was clear. Thus, the Lithol Rubine B had reacted with the cationic quat compound, showing that it has the requisite anionic character to be useful in the method of the present invention.

Observations of all of the test tubes for the samples of Jarocol Straw Yellow dye and Methylene Blue showed that these compounds are cationic in nature, since Test Tube 2 for both of these samples showed a clay layer which was colored and a water layer that was clear. Thus, these samples that are cationic in nature react with the “clean” clay directly since, as described above, samples of clay readily undergo cation exchange and are able, for example, to undergo surface modification by cationic compounds.

Furthermore, observations of all of the test tubes for the samples of D&C Red No. 22, FD&C Blue No. 1, and FD&C Yellow No. 5 showed that these compounds will also be effective as anionic molecules of interest for the present invention. Specifically, Test Tube 1 for each of these 3 dyes shows a reaction of the organoclay and the dye. Likewise, Test Tube 2 for each of these 3 dyes reveals that these 3 dyes have no affinity for the “clean” clay, which is further evidence that the colored portion of each of these 3 dyes is anionic in nature. These 3 dyes did not result in a reaction product with quat as highly insoluble as the reaction product of Lithol Rubine B and quat. This can be seen by comparing Test Tube 3 for these 3 dyes with Test Tube 3 for Lithol Rubine B. However, D&C Red No. 22, FD&C Blue No. 1, and FD&C Yellow No. 5 react with quat to an extent that reveals that these 3 dyes have enough anionic character to be used in and to benefit from the method of the present invention.

Thus, such testing enables a user to determine what compounds or molecules have the requisite anionic character to benefit from the present method, wherein the dispersibility of such anionic molecules of interest is significantly increased.

### Example 2

### Preparation of the Bentonite Clay Slurry

As described in detail above, the use of a clay is preferred, in certain embodiments of the present invention, as the high surface area substrate for reacting with an organic cationic compound to become an organoclay and to be further used in increasing the dispersibility of an anionic molecule of interest. Thus, it is necessary to understand how such a clay is prepared. The following two methods were employed for preparing a slurry of bentonite clay:

Method 1: Solid bentonite clay was dispersed by slowly mixing about 3% by weight of the bentonite clay in 97% by weight of water at room temperature. This mixture was mixed for 8 hours in a high-speed mixer in order to obtain a clay slurry. (Alternatively, to prepare a clay slurry, the mixture may be sheared in a high-shear device such as a Manton-Gaulin Homogenizer.) Possibly, this mixing step aids in separating the clay into the individual platelets of the clay.

Subsequently, the clay slurry was separated by decanting, whereby the top fraction contained the clay slurry to be collected and used, and the waste that settled to the bottom was discarded. A small portion of the clay slurry was then weighed and placed in an oven for 2 hours at about 100° C. in order to evaporate out all the water. The dried clay was then weighed to determine the solid weight percentage of the clay in the slurry. The solid weight percentage of the clay is typically from about 1 to about 4 or 5% by weight of the clay slurry.

Method 2: In this method, the clay slurry was prepared according to Method 1 above; however, samples of the slurry were centrifuged for various time periods (ranging from 1 minute to 9 minutes) to determine the time needed to remove most of the large undissolved foreign particles, as observed under microscope. The optimum time for centrifugation was determined to be about 5 minutes; thus the entire clay slurry sample was centrifuged for about 5 minutes. The solid weight percentage of the bentonite clay slurry was then determined as described in Method 1 above, and was found to be 1.57% solids by weight.

### Example 3

### Determination of Optimal Clay:Quat Ratio

As discussed above, the amount of the organic cationic compound (such as a quat) to be added to the high surface area substrate (such as a clay) is important, in that the user may wish to add an amount of quat that satisfies more than 100% of the clay's CEC to make sure that enough positive charge remains on the surface of the organoclay to bind the anionic molecule of interest. Thus, an important step involves knowing how to determine the optimal clay:quat ratio for a given clay.

In the present Example, the optimal clay/quat ratio was determined for various samples of standard Bentonite clay, sheared standard Bentonite clay, white Bentonite clay (Southern Clay Bentonite L-400) and milled white Bentonite clay. This determination employed the Methylene Blue Spot Test, wherein a standardized solution of methylene blue (which is cationic in nature) was slowly added to a fixed amount of clay. The end points observed reflected an experimental volume of methylene blue added to the clay slurry which was used to calculate the CEC for the given sample of clay.

In this Example, 10 grams of each clay slurry, having a known solids content of approximately 3% by weight, were weighed into a 250 mL Erlenmeyer flask. Then, approximately 50 mL of distilled water was added to each sample, and each clay slurry sample was then stirred using a magnetic stirrer. Subsequently, 2 mL of 5 N sulfuric acid was added to each sample, and the samples were again stirred.

For each sample, a few drops of a standardized methylene blue solution (wherein 1 mL=0.01 milliequivalents or mEq) were added from a graduated burette. The solution was allowed to mix and then the flask was washed down with distilled water. While the solids were suspended, one drop of the liquid from each sample was removed with a stirring rod and placed on filter paper (Whatman #1 filter paper). Each sample was labeled according to its respective burette reading in increments of 0.1 mL. At this point, no greenish-blue halo should be seen surrounding the dyed solids.

Subsequently, increments of 0.2 to 0.5 mL of the methylene blue solution were added to each sample, with stirring, at least 5 minutes after each previous addition. After each addition of the methylene blue solution, the flask was washed down with distilled water. After 5 minutes of stirring, the spot test was repeated on filter paper, and the respective burette reading for each spot test was recorded for each of the samples.

When a faint greenish-blue halo appeared surrounding the suspended solids of the spot test, the mixture was allowed to stir for an additional 10 minutes, and the spot test was repeated. When the halo persisted, this indicated that the end point had been exceeded, and the test was complete. The volume of methylene blue used was recorded.

Thus, the saturation point of the cation exchange of the methylene blue dye onto the surface of each type of clay was determined by adding an excess of the cationic methylene blue dye to each sample of clay. This amount of methylene blue solution needed to reach the end point was used to calculate the Cation Exchange Capacity (“CEC”) for each clay being studied. Specifically, the CEC for each clay was calculated as follows:

$$CEC = \frac{\begin{matrix}amount of methylene blue ( mL ) \times \\ standardized concentration ( meth . blue ) \times 100\end{matrix}}{( g of slurry \times \% solids )}$$

The CEC is expressed as milliequivalents (or mEq) of methylene blue per 100 grams of clay. The values obtained for the CEC of each clay are illustrated in Table 2 below.

Determining the CEC for each clay sample was important because this calculation in turn allowed the calculation of the optimal clay:quat ratio for each type of clay. Specifically, the CEC values were used as follows to calculate values for the optimal clay:quat ratio for each clay:

$$Clay : Quat Ratio = \frac{CEC / 1 g Clay}{1000} \times 555 ( Molecular Weight of Quat )$$

The molecular weight of 555 represents the molecular weight of Adogen 442, the quat of choice for the calculations performed herein. The results of each determination of the optimal clay:quat ratio for the various clays are shown below in Table 2.

TABLE 2

| | Particle Size | CEC | Adogen 442 |
|---|---|---|---|
| | Average (μm) | (mEq/100 g Clay) | (Clay/Quat Ratio) |
| Standard | 3.108 | 141.1 | 1:0.7825 |
| Bentonite | | | |
| Clay | | | |
| Sheared | 1.624 | 160.0 | 1:0.8881 |
| Standard | | | |
| Bentonite | | | |
| Clay | | | |
| White | 7.374 | 74.3 | 1:0.4124 |
| Bentonite | | | |
| Clay | | | |
| Milled | 0.633 | 77.3 | 1:0.4290 |
| White | | | |
| Bentonite | | | |
| Clay | | | |

The clay/quat ratio values listed in Table 2 above thus represent approximate calculated equivalent values for the quat Adogen 442, based on weight ratio. Thus, these values may reflect the minimum clay:quat ratio needed to achieve bonding of the anionic molecule of interest onto the cationically modified surface of the clay. As described above, the user may desire to use quat in an amount that satisfies, for example, more than 100% to about 130% of the clay's CEC, so that excess quat is available on the surface of the clay to bind the anionic molecule of interest.

The above results recorded in Table 2 further indicate that reducing the mean particle size value of the standard Bentonite clay particles had the effect of increasing the CEC of the standard Bentonite clay. The shearing for the sample of Sheared Standard Bentonite Clay (obtained by using a Manton-Gaulin Homogenizer) served to reduce the mean particle size of the Standard Bentonite Clay from 3.108 μm to 1.624 μm, and the CEC was thereby increased approximately 12%. Thus, the reduction of particle size was important for increasing the CEC because of the increase in exposed surface area available for cationic exchange with the quat.

The effects of increased surface area were not quite as apparent for the white Bentonite clay, which exhibited only a minor increase in its CEC when milled in a Laboratory Horizontal Mill. The 90% reduction in mean particle size value, resulting from the milling of the white Bentonite clay, reflected only about a 4% increase in CEC.

The above findings, therefore, aided in the present invention in that the optimal clay:quat ratios for various grades of clay were determined, and the clay:quat ratios were predicted as a function of particle size. Furthermore, the above findings provided CEC values for various clay samples so that the CEC values could be used to determine what amount of quat constitutes an “excess” of quat, wherein an excess of quat (with respect to the CEC of the clay) provides partially positively charged sites on the surface of the organoclay to which the anionic molecule of interest may bind.

### Example 4

### Preparation of Organoclay

As previously discussed, an organoclay (wherein the surface of a clay has been cationically modified to comprise a quat) is used in certain preferred embodiments of the present invention as the substrate to increase the dispersibility of the anionic molecule of interest. Thus, it is necessary to understand the steps involved in the preparation of the organoclay.

In the present Example, an organoclay was prepared using samples of the clay slurry prepared in Example 2 above and using the experimental calculations and data for CEC values and optimal clay:quat ratios from Example 3 above. First, a portion of the bentonite clay slurry from Example 2, Method 2 above was weighed, heated to 55° C., and mixed in a blender at high speed. Using the solid weight percentage of the clay (1.57%, obtained from the procedure above in Example 2), 37.5% by weight of quat was added to 62.5% by weight of the clay slurry to obtain a clay:quat solid weight ratio of 1.0:0.75. As thoroughly discussed above in Example 3, the amount of quat needed to cationically modify the bentonite clay was determined by the Methylene Blue Spot Test method.

After mixing for an additional 5 minutes, the mixture was allowed to sit for 30 minutes. Thereafter, the material floating at the top (the organoclay that had formed) was collected, filtered, washed with water, and dried. The resulting dried solids were ground using a mortar and pestle to obtain a fine powder of organoclay.

At this point, particle size analysis may be performed to determine the dispersibility of the organoclay in a chosen application system. For example, a sample of the organoclay fine powder may be dispersed into mineral oil, whereby mineral oil acts as the application system into which it may normally be difficult for the anionic molecule of interest (such as an anionic dye) to disperse. The dispersion of the organoclay powder in mineral oil acts as the “control” sample, and it is expected that dispersibility of the organoclay into the mineral oil will be relatively high because of the organic character of both the organoclay and the mineral oil. Thus, for the control sample (or the sample of organoclay dispersed in mineral oil), the mean particle size value should be low, indicating that the organoclay particles readily disperse into the mineral oil and do not agglomerate.

An experimental sample may then be prepared and subsequently compared to the control sample formed above. Specifically, the anionic molecule of interest is first chosen. Herein, Lithol Rubine B is used as an example of an anionic molecule of interest that may be chosen. An amount of Lithol Rubine B may be (1) added to a desired amount of quat, whereby the anion/quat pair are reacted onto the surface of a clay; (2) added to an organoclay (whereby the surface of a clay has already been modified by an organic cationic compound such as a quat); or (3) added to a sample of clay, whereby the anion/clay mixture is subsequently reacted with an amount of quat. The resulting anion/organoclay composition undergoes the same steps described above for the control organoclay sample, such as being collected, filtered, washed with water, and dried. The resulting dried solids were ground using a mortar and pestle to obtain a fine powder of the anion/organoclay composition.

Subsequently, the experimental sample of the anion/organoclay composition that has been dried is dispersed into mineral oil. Particle size analysis is then performed on a sample of the mineral oil dispersal of the anion/organoclay composition. The particle size measurements are compared to those described above for the control sample. Specifically, it is desirable for the particle size measurements of the experimental sample to approximate those of the control sample. This will indicate to the user that the anion/organoclay composition dispersed into the mineral oil just as well as the organoclay alone did. Such results will show that even though an anionic dye (such as Lithol Rubine B) is typically unable to disperse in a system such as mineral oil, the use of the organoclay serves to increase the dispersibility of the anionic dye into an organic system such as mineral oil and thereby increase the ability of the anionic dye to color the system. Thus, in general, the mean particle size value and the particle size distribution data and curves for the organoclay that has the anionic molecule of interest incorporated onto its surface should approximate the particle size data for the organoclay alone, thereby indicating successful dispersion of the anion/organoclay composition into the application system, such as mineral oil.

To measure the particle size (and thereby the dispersibility) of both the control sample and the experimental sample, a light scattering method was employed. The light scattering methodology included the use of a computerized Malvern particle size analyzer, in which a small amount of each of the control sample and the experimental sample was analyzed. A Malvern Mastersizer 2000 dry unit Scirocco 2000 Model #APA 2000, commercially available from Malvern Instruments Ltd. in Worchestershire, United Kingdom, was used to perform the particle size analysis. Both dry and wet samples were tested according to this method.

For dry samples of either the organoclay powder of the anion/organoclay powder, the following procedure was used. (This procedure describes particle size analysis of the dry organoclay powder and the dry anion/organoclay powder before any dispersal into a liquid application system, such as the mineral oil described above.) First, both the feed tray and feed chamber were cleaned. Next, from about 2 to about 4 grams of either the control sample powder or the experimental sample powder are loaded into the feed tray. After selecting the Dry SOP (Standard Operating Procedure) and entering the appropriate label or identification information, analysis of the sample is initiated by right-clicking on the start icon. The Dry SOP parameters are provided in Table 3 below:

TABLE 3
Dry SOP

| Criteria | Setting | Value |
|---|---|---|
| Sample Selection | Scirocco 2000(A) | |
| Material | Anion/Organoclay | |
| | or Organoclay | |
| | Refractive Index | 1.38 |
| | Absorption | 0.1 |
| Labels | Factory Settings | |
| Reports & Saving | Factory Settings | |
| Measurement | Measurement Time | 12 seconds |
| | Measurement Snaps | 12,000 |
| | Background Time | 12 seconds |
| | Background Snaps | 12,000 |
| Sampler Settings | Sample Tray | General Purpose (<200 g) |
| | Dispersive Air Pressure | 3 Bar |
| | Aliquots | Single |
| | Vibration Feed Rate | 40% |
| | Measurement Cycle | Single |

Upon completion of the analysis, a graph representing the particle size distribution data and the corresponding volume percent data may be obtained by selecting the records tab, right-clicking to highlight the desired record, and then selecting the results analysis (BU) tab. As described earlier, the particle size distribution data for the sample of dry anion/organoclay powder can be compared to the particle size distribution data for the sample of dry organoclay powder, which acts as the control sample. The particle size distribution data for the dry anion/organoclay powder should be very similar to the particle size distribution data for the dry organoclay powder.

For “wet” samples, or samples wherein either the dry organoclay powder or the dry anion/organoclay powder has been dispersed into a liquid application system, similar particle size analysis procedures may be employed. Specifically, as described above, mineral oil may be chosen as the dispersant or the “application system” of interest into which the anionic molecule of interest may typically experience difficulty in dispersing. Thus, the particle size distribution data obtained for the “wet” samples shows how well the experimental sample (the anion/organoclay powder) disperses in mineral oil as compared to how well the control sample (organoclay powder alone) disperses in mineral oil.

The Wet SOP (Standard Operating Procedure) for the Malvern Mastersizer is selected, and a manual measurement is initiated by first selecting the options icon. The Wet SOP parameters are provided below in Table 4. After entering the appropriate information (for example, what material is under analysis and what liquid dispersant is being employed), the liquid sample well is checked to ensure that it is empty. If the sample well is not empty, it may be drained by right-clicking the empty button on the accessory menu. The empty liquid sample well was then cleaned by clicking the clean icon.

Next, the proper liquid is selected to flush the Hydro Unit. Using a pipette, the wet sample (either the control sample or the experimental sample) is slowly transferred into the sample well until the system prompts the user to stop adding more of the sample and to initiate analysis. Analysis of the wet sample was initiated by right-clicking the start icon.

TABLE 4
Wet SOP

| Criteria | Setting | Value |
|---|---|---|
| Sample Selection | Hydro 2000S(A) | |
| Material | Anion/Organoclay | |
| | or Organoclay | |
| | Refractive Index | 1.38 |
| | Absorption | 0.1 |
| Dispersant Name* | Mineral Oil | |
| | Refractive Index | 1.4 |
| Labels | Factory Settings | |
| Reports & Saving | Factory Settings | |
| Measurement | Measurement Time | 12 seconds |
| | Measurement Snaps | 12,000 |
| | Background Time | 12 seconds |
| | Background Snaps | 12,000 |
| Sampler Settings | Pump/Stir Speed | 2500 RPM |
| | Tip Displacement | 100% |
| | Ultrasonics | Checked pre-measurement |
| | | 20 sec. |
| | Tank Fill | Manual |
| Cycles | Aliquots | Single |
| | Measurements | 2 per aliquot |
| | Cleaning | Before each aliquot |
| | | (check enable) |
| | Clean Mode | Manual |
| | Measurement Cycle | Multiple |
| | Delay | 10 Seconds |

*The dispersant name and its refractive index can be changed for a particular dispersant used.

Upon completion of the analysis, a graph representing the particle size distribution data and the corresponding volume percent data may be obtained by selecting the records tab, right-clicking to highlight the desired record, and then selecting the results analysis (BU) tab. This method of determining the particle size data for samples of both organoclay (used as the control) and the anion/organoclay composition allows the user to determine the extent to which the anion/organoclay composition is dispersing in the system of choice. Ideally, the particle size results for samples of the anion/organoclay composition will approximate particle size results for samples of the organoclay alone, thereby signifying that the dispersibility of the anionic molecule of interest has been greatly increased via its being bound to the organoclay and signifying that the anionic molecule of interest has become more compatible with that given system.

### Example 5

### Determining Dispersibility of Four Anionic Dyes After Incorporation Into Anion/Organoclay Compositions

The preparation of the organoclay discussed in Example 4 above allowed experimentation to commence regarding the increased dispersibility of certain anionic molecules of interest after those anionic molecules had been reacted onto the surface of the organoclay via the quat. In the present Example, four anionic dyes were incorporated into samples of organoclay via reacting with the quat located on the surface of the organoclay. The dyes involved in this Example included: FD&C Blue No. 1; Lithol Rubine B; D&C Red No. 22; and D&C Green No. 5. The D&C Green No. 5 dye (CAS Number 4403-90-1) is a well-known anthraquinone color having the empirical formula C₂₈H₂₂N₂O₈S₂.2Na.

The objective of the present Example was not only to determine the equivalence points at a fixed clay:quat ratio for the four anionic dyes listed above, but also to determine the effects that varying the clay:quat ratio had on the dye equivalence. The equivalence point for each anionic dye was recognized as the moment when the water phase of the anionic dye/organoclay composition began to turn a weak color. In other words, the equivalence point for each dye indicated the point at which the anionic dye would bleed or fail to be dispersible when the dye/organoclay composition is placed in an aqueous environment. This equivalence point, then, also indicates the point at which the weak bonding sites on the clay have been satisfied.

Determination of the equivalence point for the four anionic dyes began with the preparation of the organoclay and the subsequent addition of the dye to form the anionic dye/organoclay compositions. The organoclay, having a clay:quat ratio of 1.0:0.77, was prepared by first heating 150 grams of clay slurry (wherein the clay slurry comprises 3.24 grams of bentonite clay and thus comprises 2.16% solids) on a hot plate to approximately 65° C. Simultaneously, 2.495 grams of quat were dissolved in hot water. The quat used in this Example was Adogen 442, and the solution contained a quat:water ratio of 1:20. The quat solution was placed on the same hot plate and heated to 65° C., while being stirred to aid in the dissolution of the quat.

The bentonite clay slurry was added to a Waring blender and was allowed to mix under high speed agitation (speed 6) for about 1 minute. The quat solution was then added slowly to the clay slurry and was allowed to react for approximately 25-30 minutes. After this time, the blender was stopped for a few seconds to ensure adequate floccing. Subsequently, small increments of each anionic dye were added until the respective equivalence point was reached for each particular anionic dye.

The equivalence points for the four anionic dyes being studied are shown in

TABLE 5
Equivalence Points for 4 Dyes in Organoclay;
Clay:Quat Ratio of 1:0.77

| Anionic Dye | Equivalence Point (grams) |
|---|---|
| FD&C Blue No. 1 | 0.3750 |
| D&C Green No. 5 | 0.4853 |
| D&C Red No. 22 | 0.4330 |
| *Lithol Rubine B | 0.4103 |

*Indicates color change

The process described above was repeated using several different clay:quat ratios including 1:0.5 and 1:0.6 (less quat than the experiment described above) and 1:0.9 (an excess of quat with respect to the experiment described above). Tables 6 and 7 below show the equivalence points for two of the anionic dyes (specifically, D&C Red No. 22 and Lithol Rubine B) when the clay:quat ratio was changed to 1:0.6, 1:0.9, and 1:0.5.

TABLE 6
Equivalence Point of D&C Red No. 22 for Various Clay:Quat Ratios

| | Equivalence | Equivalence |
|---|---|---|
| | Point (grams) at | Point (grams) at |
| Anionic Dye | Clay:Quat Ratio of 1:0.6 | Clay:Quat Ratio of 1:0.9 |
| D&C Red No. 22 | 0.1776 | 0.6288 |

TABLE 7
Equivalence Point of Lithol Rubine B for Various Clay:Quat Ratios

| | Equivalence | Equivalence |
|---|---|---|
| | Point (grams) at | Point (grams) at |
| Anionic Dye | Clay:Quat Ratio of 1:0.5 | Clay:Quat Ratio of 1:0.6 |
| *Lithol Rubine B | 0.0693 | 0.1471 |

*Indicates color change

As indicated by the data in Tables 6 and 7 above, the equivalence points of the anionic dyes are sensitive to the clay:quat ratio. As the amount of quat used decreases, there is a proportional decrease in the equivalence point or the amount of the anionic dye (in grams) needed to reach the equivalence point. Similarly, when the amount of quat used was increased, a proportional increase in the equivalence point was observed.

The results of the present Example further reveal that the anionic dyes form a complex with the quat that has been cationically exchanged onto the surface of the clay. Significantly, when the amount of quat used is decreased, the charge distribution over the entire clay surface strongly favors cationic exchange of quat. As a result, the equivalence points for the anionic dyes at these lower amounts of quat used were extremely small relative to the equivalence point values when higher amounts of quat were used. Thus, as the clay:quat ratio is increased, the ability to form weaker exchanges is increased, and the formation of a complex of the anionic dye weakly exchanged to the quat on the surface of the organoclay is favored.

Additionally, Tables 5 and 7 above indicate that a color change took place for Lithol Rubine B at all three of the clay:quat ratios used to test Lithol Rubine B (ratios of 1:0.77, 1:0.6, and 1:0.5). This color change may be attributed to the interaction of the quat with the chromophore of the anionic dye.

Next, solvent extraction data was obtained for three of the anionic dye/organoclay compositions formed above. Specifically, samples of the anion/organoclay compositions comprising D&C Red No. 22, D&C Green No. 5, and FD&C Blue No. 1 were dispersed in various liquid application systems to determine the extent to which the dye was extracted from the dye/organoclay compositions. The results of this study are shown below in Table 8:

TABLE 8
Solvent Extraction Data for 3 Anionic Dye/Organoclay Compositions;
Clay:Quat Ratio = 1:0.77

| | D&C | D&C | FD&C |
|---|---|---|---|
| Liquid Dispersant | Red No. 22 | Green No. 5 | Blue No. 1 |
| Water | − | − | − |
| Water/NH₄ | − | − | +/− |
| Water HCl | − | − | − |
| Acetone | + | + | + |
| Toluene | + | + | + |
| Isopropyl Alcohol | + | + | + |
| Soy Oil | − | +/− | +/− |
| Mineral Spirits | − | − | − |

+ Large Dye Extraction
+/− Marginal Extraction
− Minimal Dye Extraction

The results shown in Table 8 above indicate that the three anionic dyes tested were strongly bound or affixed to the surface of the organoclay, regardless of the type of system into which the anion/organoclay composition was placed. In aqueous systems, acidic systems and basic systems the anionic dyes being analyzed generally exhibited no appreciable level of extraction. In various organic systems, i.e., soy oil and mineral spirits no appreciable level of extraction was observed. In contrast, in other organic systems, i.e., acetone, toluene and isoproply alcohol, extraction was observed. However, the actual amount of extraction is difficult to quantitate because the anionic dye/organoclay composition itself may be dispersed.

In addition, the powder texture or softness of each of the 4 anionic dye/organoclay powder compositions was studied and analyzed during the present Example. The results of these studies are shown in Table 9 below:

TABLE 9
Texture of Dry Anionic Dye/Organoclay Compositions;
Clay:Quat Ratio = 1:0.77

| Anionic Dye | Powder Texture |
|---|---|
| FD&C Blue No. 1 | + |
| D&C Green No. 5 | + |
| D&C Red No. 22 | + |
| Lithol Rubine B | +/− |

+ Soft Powder
+/− Intermediate Hardness
− Hard Agglomerates

The results shown in Table 9 above indicate that when all four of the anionic dyes being studied are reacted with organoclay, the resulting anion/organoclay composition may be dried and powdered, whereby the powder form of the anion/organoclay composition is soft, manageable, and useful. Thus, the results show that the dry powder form of the anion/organoclay compositions formed herein will be useful in dry, powder-like systems or end uses.

Additional experiments have confirmed that free quat is able to interact with the anionic dye and change its color properties. This effect is well known in that for some colored anionic molecules of interest, the type of offsetting positive charge used to react with the anion alters the geometry of the anion, thereby causing slight shifts in frequency and intensity of color. Yet, for many other colored anions, no such changes are detected.

What is claimed:

1. A composition comprising:
i) an anion ionically bound to an organic cationic compound, and
ii) a high surface area substrate;
wherein the organic cationic compound is chemically bound to the high surface area substrate.

2. The composition of claim 1, wherein said substrate is a silicate.

3. The composition of claim 2, wherein said silicate is zeolite.

4. The composition of claim 1, wherein said substrate is a clay.

5. The composition of claim 1, wherein said organic cationic compound comprises a cation selected from the group consisting of quaternary ammonium, quaternary phoshponium, and ternary sulfonium.

6. The composition of claim 1, wherein said organic cationic compound comprises a linear, saturated alkyl moiety having 12 to 22 carbon atoms and one or more moieties selected from the group consisting of a linear, saturated alkyl moiety having 12 to 22 carbon atoms; a branched, saturated alkyl moiety having 12 to 22 carbon atoms; a linear, unsaturated alkyl moiety having 12 to 22 carbon atoms; a branched, unsaturated alkyl moiety having 12 to 22 carbon atoms; a benzyl moiety including fused ring moieties having linear or branched 1 to 22 carbon atoms in the alkyl portion of the structure; a substituted benzyl moiety including fused ring moieties having linear or branched 1 to 22 carbon atoms in the alkyl portion of the structure; a phenyl moiety and substituted phenyl including fused ring aromatic substituents; a substituted phenyl moiety including fused ring aromatic substituents; a beta, gamma-unsaturated moiety having six or less carbon atoms or hydroxyalkyl groups having two to six carbon atoms; and hydrogen.

7. The composition of claim 1, wherein said organic cationic compound comprises a branched, saturated alkyl moiety having 12 to 22 carbon atoms and one or more moieties selected from the group consisting of a linear, saturated alkyl moiety having 12 to 22 carbon atoms; a branched, saturated alkyl moiety having 12 to 22 carbon atoms; a linear, unsaturated alkyl moiety having 12 to 22 carbon atoms; a branched, unsaturated alkyl moiety having 12 to 22 carbon atoms; a benzyl moiety including fused ring moieties having linear or branched 1 to 22 carbon atoms in the alkyl portion of the structure; a substituted benzyl moiety including fused ring moieties having linear or branched 1 to 22 carbon atoms in the alkyl portion of the structure; a phenyl moiety and substituted phenyl including fused ring aromatic substituents; a substituted phenyl moiety including fused ring aromatic substituents; a beta, gamma-unsaturated moiety having six or less carbon atoms or hydroxyalkyl groups having two to six carbon atoms; and hydrogen.

8. The composition of claim 1, wherein said organic cationic compound comprises a linear, unsaturated alkyl moiety having 12 to 22 carbon atoms and one or more moieties selected from the group consisting of a linear, saturated alkyl moiety having 12 to 22 carbon atoms; a branched, saturated alkyl moiety having 12 to 22 carbon atoms; a linear, unsaturated alkyl moiety having 12 to 22 carbon atoms; a branched, unsaturated alkyl moiety having 12 to 22 carbon atoms; a benzyl moiety including fused ring moieties having linear or branched 1 to 22 carbon atoms in the alkyl portion of the structure; a substituted benzyl moiety including fused ring moieties having linear or branched 1 to 22 carbon atoms in the alkyl portion of the structure; a phenyl moiety and substituted phenyl including fused ring aromatic substituents; a substituted phenyl moiety including fused ring aromatic substituents; a beta, gamma-unsaturated moiety having six or less carbon atoms or hydroxyalkyl groups having two to six carbon atoms; and hydrogen.

9. The composition of claim 1, wherein said organic cationic compound comprises a branched, unsaturated alkyl moiety having 12 to 22 carbon atoms and one or more moieties selected from the group consisting of a linear, saturated alkyl moiety having 12 to 22 carbon atoms; a branched, saturated alkyl moiety having 12 to 22 carbon atoms; a linear, unsaturated alkyl moiety having 12 to 22 carbon atoms; a branched, unsaturated alkyl moiety having 12 to 22 carbon atoms; a benzyl moiety including fused ring moieties having linear or branched 1 to 22 carbon atoms in the alkyl portion of the structure; a substituted benzyl moiety including fused ring moieties having linear or branched 1 to 22 carbon atoms in the alkyl portion of the structure; a phenyl moiety and substituted phenyl including fused ring aromatic substituents; a substituted phenyl moiety including fused ring aromatic substituents; a β, γ-unsaturated moiety having six or less carbon atoms or hydroxyalkyl groups having two to six carbon atoms; and hydrogen.

10. The composition of claim 4, wherein said clay is selected from the group consisting of a bentonite, a montmorillonite, a beidellite, a hectorite, a saponite, a stevensite, and mixtures thereof.

11. The composition of claim 1, wherein said anion is a component of a dye.

12. The composition of claim 1, wherein said anion is a component of a pigment.

13. The composition of claim 1, wherein said anion is a component of a catalyst.

14. The composition of claim 1, wherein said anion is a component of a redox agent.

15. The composition of claim 1, wherein said anion is a component of a medicinal substance.

16. The composition of claim 11, wherein said dye is selected from the group consisting of Lithol Rubine B, D&C Red No. 22, FD&C Blue No. 1, and D&C Green No. 5.

17. The composition of claim 15, wherein said medicinal substance is selected from the group consisting of zinc ricinoleicite, ricinoleic acid, calcium ethylbutanoate, aluminum nicotinate.

18. A method of increasing the surface area of an anionic portion of a molecule in an application system, comprising (i) bonding the anionic portion of the molecule to an organic cationic compound to form an anionic/cationic complex and (ii) bonding the anionic/cationic complex to a high surface area substrate wherein said substrate is capable of cation exchange because of mobile cations located at its surface; thereby forming a composition comprising an anionic/cationic and high surface substrate complex wherein the anionic portion of the molecule incorporated onto the high surface area substrate displays an enhanced surface area in said application system than the anionic portion of a molecule would display alone.

19. A product produced by the method of claim 18 wherein the anionic portion of the molecule has an enhanced surface area.

20. The method of claim 18 wherein the enhanced surface area of the anionic portion of the molecule confers a desired physical, chemical, biological or therapeutic benefit to an application system.

21. The method of claim 20, wherein said physical, chemical, biological or therapeutic activity is selected from the group consisting of optical activity, insolubility, catalytic activity, oxidative activity, reductive activity, anti-cholinergic activity, anti-spasmodic activity, anti-microbial activity, anti-fungal activity, muscle-relaxant activity, disinfectant activity, anti-bacterial activity, leachability and dispersibility.

22. The method of claim 18 for producing a dry powder pigment.

23. A dry powder pigment produced by the method of claim 22.

24. The method of claim 18 for producing a dry powder colorant.

25. A dry powder colorant produced by the method of claim 24.

26. The method of claim 18 for reducing the leachibility of the anionic portion of the molecule in an application system.

27. A product produced by the method of claim 26 wherein the anionic portion of the molecule has reduced leachability.

28. A method of tinting a plastic comprising incorporating the dry powder pigment of claim 23 into said plastic.

29. A method of tinting a polymer comprising incorporating the dry powder pigment of claim 23 into said polymer.

30. A method of tinting a resin comprising incorporating the dry powder pigment of claim 23 into said said resin.

31. A tinted plastic produced by the method of claim 28.

32. A tinted polymer produced by the method of claim 29.

33. A tinted resin produced by the method of claim 30.

34. A method of tinting a plastic comprising incorporating the dry powder colorant of claim 25 into said plastic.

35. A method of tinting a polymer comprising incorporating the dry powder colorant of claim 25 into said polymer.

36. A method of tinting a resin comprising incorporating the dry powder colorant of claim 25 into said resin.

37. A tinted plastic produced by the method of claim 34.

38. A tinted polymer produced by the method of claim 35.

39. A tinted resin produced by the method of claim 36.
